(19) United States
(12) Patent Application Publication
(10) Pub. No.: US 2009/0070067 A1
(43) Pub. Date: Mar. 12, 2009

(54) Method and device for recording a distance

(76) Inventor: Leopold Beer, Reutlingen (DE)

Correspondence Address: KENYON & KENYON LLP, ONE BROADWAY, NEW YORK, NY, 10004, US

(21) Appl. No.: 12/283,451

(22) Filed: Sep. 11, 2008

(30) Foreign Application Priority Data
Sep. 12, 2007 (DE) 102007043490.3

(51) Int. Cl. G01C 22/00

(52) U.S. Cl. 702/160

(57) ABSTRACT

A pedometer and a method for recording a distance covered. The pedometer includes an acceleration sensor by which the movement of the pedometer is recorded. In order to be able to ascertain the number of paces and the distance covered from the movement, an evaluation unit is provided which evaluates the signals of the acceleration sensor. If the carrier of such a pedometer is moving not only in one plane, but also uphill and downhill, inaccuracies occur in the ascertainment of the route which cannot be rectified only by an acceleration sensor. For this purpose, a pressure sensor is integrated into the pedometer, by which the evaluation unit is also able to take into account the influence of the change in altitude during the movement, whereby the route covered is able to be ascertained more accurately.

### CROSS REFERENCE

The present application claims the benefit under 35 U.S.C. § 119 of German Patent Application No. DE 102007043490.3 filed on Sep. 12, 2007, which is expressly incorporated herein by reference in its entirety.

### FIELD OF THE INVENTION

The present invention relates to a pedometer and a method for recording a distance covered.

### BACKGROUND INFORMATION

A pedometer for a runner is described in European Patent No. EP 977974 A1, by the use of which one may conclude on the distance covered, using an acceleration sensor. By inputting personal data such as the weight of the runner, it is possible to calculate the number of calories used up. A display is provided for the runner, which is accommodated in a small portable unit, so that he can read the distance covered. The communication between the sensor, that is fastened in or on the shoe, and the display unit is provided to be wireless, in this instance.

Furthermore, a method and a device are described in German Patent Application No. DE 102 01 134 A1, in which the piezoelectric effect of a pressure sensor is utilized for counting paces. A piezoelectric pressure sensor foil is accommodated in the sole of a shoe, for this purpose.

An object of the present invention is to provide a pedometer having a greater accuracy of the distance.

### SUMMARY

The present invention relates to a pedometer and a method for recording a distance covered. It is provided, in this context, that the pedometer may include an acceleration sensor by which the movement of the pedometer is recorded. In order to be able to ascertain the number of paces and the distance covered from the movement, an evaluation unit is provided which evaluates the signals of the acceleration sensor. If the carrier of such a pedometer is moving not only in one plane, but also uphill and downhill, inaccuracies occur in the ascertainment of the route which cannot be rectified only by an acceleration sensor. For this purpose, a pressure sensor is integrated into the pedometer, according to the present invention, by which the evaluation unit is also able to take into account the influence of the change in altitude, whereby the route covered is able to be ascertained more accurately.

The pressure sensor is advantageously designed in such a way that it emits a pressure signal based on a change in the environmental pressure. This may be done, for instance, using a conventional micromechanical diaphragm sensor.

In one refinement of the present invention, it may also be provided that the evaluation unit, besides ascertaining the route covered, also ascertains the altitude reached in the process as an altitude profile, and stores it in a suitable memory.

Using the information as to which differences in altitude have been overcome by the movement, the evaluation unit is also able to calculate more accurately the calorie usage during the route covered.

In addition, the pedometer may be furnished with a display which optionally indicates the number of paces, the route covered, the altitude profile and/or the calorie usage on the route covered.

### BRIEF DESCRIPTION OF THE DRAWINGS

FIG. 1 shows an example embodiment of the present invention.

FIG. 2 shows a rough flow chart of the example method according to the present invention.

### DETAILED DESCRIPTION OF EXAMPLE EMBODIMENTS

Current pace counters, also called pedometers, use only an acceleration sensor or a rotational rate sensor or a (piezoelectric) pressure sensor for recording the number of paces or the route covered. According to the exemplary embodiment of the present invention, both the signal of an acceleration sensor and the signal of a pressure sensor are used for the more accurate recording of the route covered and for the calorie usage connected with it.

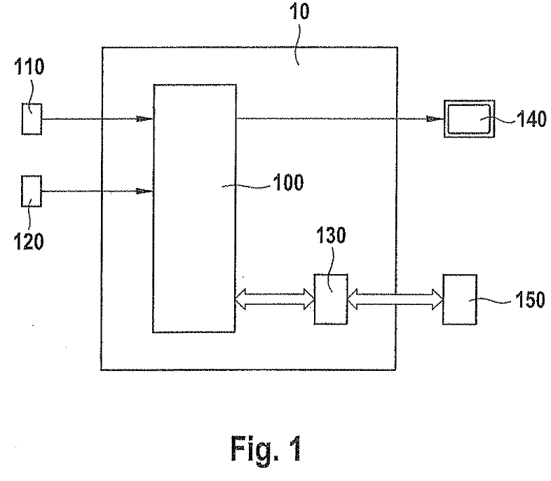

One possible exemplary embodiment in the form of a device is shown in FIG. 1. In this context, a pedometer 10, which may be carried, for instance, at the wrist, on the foot or on the shoe, has an evaluation unit 100, which may be implemented by a microprocessor, for example. Both the data of an acceleration sensor 110 and the signals of a pressure sensor 120 may be read into the evaluation unit. Together with stored data on the carrier, such as pace length, weight, age, etc., evaluation unit 100 is able to ascertain the number of paces, the route covered, the calorie usage connected with that, or is able to ascertain the altitude profile, and pass it on to a display 140 that is preferably also accommodated in pedometer 10.

For the storage of the personal data of the pedometer user, a memory 130 may be provided in pedometer 10. Since these personal data may change, external access to this memory using a suitable interface 150 is provided, according to FIG. 1, for instance, using a keyboard or another input device, which preferably is integrated into pedometer 10.

In one optional embodiment of the present invention, it may also be provided, that one read out via this interface 150, the number of paces ascertained and stored in memory 130, the route covered, the calorie usage and/or the altitude profile. It is possible in this connection to furnish the pedometer with a USB connection or another computer interface.

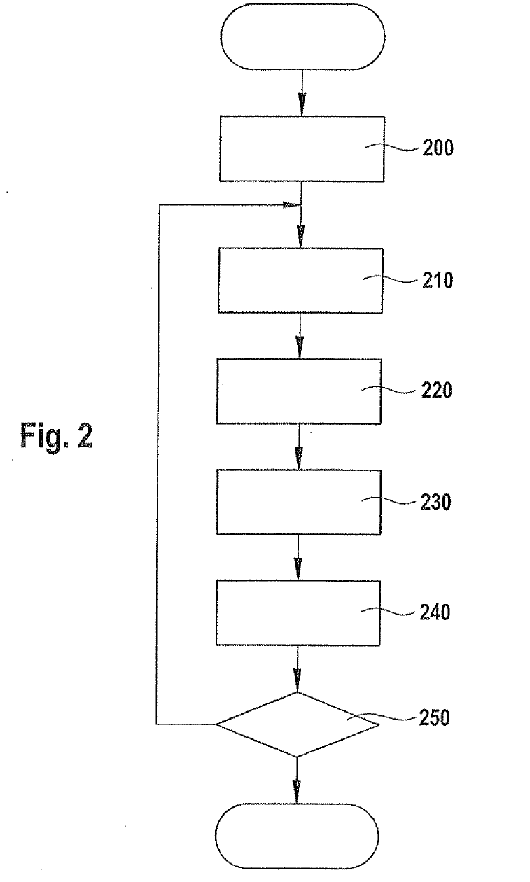

FIG. 2 shows schematically a possible flow chart of a program which shows the recording and the ascertainment of the desired values of the pedometer. Such a program may run, for instance, on a microprocessor within pedometer 10. The start of the program may be initiated directly by the carrier of the pedometer. It may also be optionally provided that the program is self-activating, in response to a detected movement by the acceleration sensor itself. After the start of the program, in step 200, the pace length, the weight and perhaps the age of the user are read in from a corresponding memory, or queried directly from the user. Thereafter the movement data are recorded in that, in step 210, first the acceleration signals are recorded and after that, in step 220, the pressure signals are recorded. By using a barometric pressure sensor, that is, a pressure sensor that emits a signal as a function of the change in the environmental pressure, a calibration of the pressure sensor is not necessary, since only the pressure changes are recorded. In step 230, in order to ascertain the route covered, the signal supplied by the acceleration sensor are utilized to calculate the number of paces. The route covered may be ascertained from the number of paces, with the aid of the pace length of the pedometer user. Since the distance thus ascertained corresponds only to the linear distance between the starting point and the target point projected onto the plane, inaccuracies may occur if substantial differences in altitude have been overcome between these two points. For this reason, the (altitude) signal of the pressure sensor is taken into account in the evaluation, in order to achieve a more correct route accuracy. With the aid of this modified, and thus more accurate route, the calorie usage of the user may also be calculated more accurately. In step 240, together with the number of paces, the route covered, the altitude signal, the altitude profile and the calorie usage may optionally be stored in the memory and/or displayed to the user. Thereupon it may be decided, also optionally, whether the recording should be broken off instead of a renewed running of steps 210 to 240, and consequently the program is ended, for instance, in that the carrier of the pedometer interrupts the recording.

In the evaluation of the calorie usage, additional data, such as the age or the general health state may be taken into account, which are held in reserve in a memory.

What is claimed is:

1. A pedometer for recording a route covered, comprising:
an acceleration sensor;
an evaluation unit adapted to generate a route signal for a route covered as a function of the acceleration signals generated by the acceleration sensor; and
a pressure sensor, the evaluation unit additionally taking into account a pressure signal generated by the pressure sensor during the generation of the route signal.

2. The pedometer as recited in claim 1, wherein the pressure sensor generates the pressure signal as a function of environmental pressure.

3. The pedometer as recited in claim 1, wherein the evaluation unit generates an altitude signal as a function of the pressure signal.

4. The pedometer as recited in claim 1, wherein the evaluation unit generates an altitude signal as a function of the acceleration signal and the pressure signal.

5. The pedometer as recited in claim 3, wherein the evaluation unit stores an altitude profile of the route covered.

6. The pedometer as recited in claim 1, wherein the pedometer has a display which displays at least one of: a number of paces, the route covered, a calorie usage on the route covered, and an altitude profile of the route covered.

7. A method for recording a route covered, comprising:
generating a route signal representing the distance covered as a function of an acceleration signal of an acceleration sensor; and
generating a pressure signal by a pressure sensor, the pressure signal being taken into account for the generation of the route signal.

8. The method as recited in claim 7, wherein the pressure signal represents an environmental pressure.

9. The method as recited in claim 7, wherein an altitude profile of the route covered at least one of generated and stored from the pressure signal, in conjunction with the acceleration signal.

10. The method as recited in claim 7, further comprising:
displaying on a display at least one of: a number of paces, a route covered, a calorie usage on the route covered, and an altitude profile of the route covered
